(19) United States
(12) Patent Application Publication
(10) Pub. No.: US 2009/0013181 A1
(43) Pub. Date: Jan. 8, 2009

(54) METHOD AND ATTESTATION SYSTEM FOR PREVENTING ATTESTATION REPLAY ATTACK

(75) Inventors: Su Gil Choi, Daejeon (KR); Sung Ik Jun, Daejeon (KR); Jin Hee Han, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunications Research Institute, Daejeon (KR)

(21) Appl. No.: 12/120,154

(22) Filed: May 13, 2008

(30) Foreign Application Priority Data
Jul. 3, 2007 (KR) 10-2007-66761

(51) Int. Cl. H04L 9/00

(52) U.S. Cl. 713/168

(57) ABSTRACT

Provided are a method and an attestation system for preventing an attestation replay attack. The method for preventing an attestation replay attack in an attestation system including an attestation target system and an attestation request system, the method including: measuring associated components when an event that affects the integrity of the attestation target system occurs; perceiving own identity information and verifying the perceived identity information; extending the measured component and the identity information into a register and logging the measured component and the identity information; generating an attestation response message including values of the log and the register when an attestation request message is received from the attestation request system; and transmitting the generated attestation response message to the attestation request system. Therefore, the method and an attestation system may be useful to provide an additional simple mathematical operation in verifying an attestation message by preventing an attestation replay attack, and thus to minimize performance degradation in the attestation system, compared to the conventional attestation processing mechanisms.

### CROSS-REFERENCE TO RELATED APPLICATIONS

This application claims the priority of Korean Patent Application No. 2007-66761 filed on Jul. 3, 2007, in the Korean Intellectual Property Office, the disclosure of which is incorporated herein by reference.

### BACKGROUND OF THE INVENTION

1. Field of the Invention

The present invention relates to a method and an attestation system for preventing an attestation replay attack, and more particularly, to a method and an attestation system for preventing an attestation replay attack capable of using an attestation message generated in a different platform as an attestation message generated in its own platform to prove to an external system that a computing platform is in a trusted state.

This work was supported by the IT R&D program of MIC/IITA [2006-S-041-02, Development of a common security core module for supporting secure and trusted service in the next generation mobile terminals].

2. Description of the Related Art

FIG. 1 is a conceptional view illustrating an operation flowchart of an attestation replay attack according to the present invention.

An attestation target system 120 transmits information that can judge trustability of its own system when the attestation target system 120 takes an attestation request from an attestation request system 110. However, the attestation request system 110 may be cheated by replaying an attestation response message generated in a trusted system 130 when an ill-intentioned user possesses the attestation target system 120, or a target system is under the external attacks and under the control of attackers.

The attestation response message is signed with an attestation identity key (hereinafter, referred to as ‘AIK’). However, a replay attack is made possible since the AIK may not prove that the attestation response message is generated in a certain platform, but means that the attestation response message is signed by a trusted platform module (TPM).

Conventional methods for preventing a replay attack are signified only when an attacker may possess a trusted system 130. However, the conventional methods are insignificant on the above-mentioned assumption since the attacker has no problem in possessing and managing the trusted system 130. In addition, it is actually difficult to apply to the field of the methods for preventing a replay attack since all the platforms should have their certificates, and the performance degradation of the trusted system 130 is expected since the trusted system 130 should verify the certificates.

Furthermore, the conventional data sealing methods as defined in a trusted computing group (hereinafter, referred to as ‘TCG’) has an advantages that the data may be used only when a certain platform is in a trusted state. However, the conventional data sealing methods do not have a function to regulate sites in which platforms using these data are arranged.

### SUMMARY OF THE INVENTION

The present invention is designed to solve the problems of the prior art, and therefore it is an object of the present invention to provide a method and an attestation system for preventing an attestation replay attack when an attacker possesses a trusted computing platform.

It is another object of the present invention to provide a method and an attestation system for preventing an attestation replay attack capable of being used in a computing platform using a trusted computing group (TCG) technology by providing the minimum additional functions to the functions as defined in the TCG technology without any change of the functions of the TCG technology.

It is still another object of the present invention to provide a method and an attestation system for preventing an attestation replay attack capable of minimizing performance degradation in generating an attestation message and verifying the attestation message.

According to an aspect of the present invention, there is a method for preventing an attestation replay attack by an attestation target system in an attestation system including the attestation target system and an attestation request system, the method including: measuring associated components when an event that affects the integrity of the attestation target system occurs; perceiving identity information in the attestation target system and verifying the perceived identity information; extending the measured components and the identity information to the size of the register and recording the components and the identity information in the register; generating an attestation response message including the log and a value of the register when an attestation request message is received from the attestation request system; and transmitting the generated attestation request message to the attestation request system.

According to another aspect of the present invention, there is provided a method for preventing an attestation replay attack in an attestation system including an attestation target system and the attestation request system, the method including: transmitting an attestation request message including a random number to the attestation target system; receiving the transmitted attestation request message including a log recording identity information of the attestation target system, and a value of a register extending the identity information; and verifying the attestation request message to confirm reliability of the attestation target system.

According to still another aspect of the present invention, there is provided an attestation system for preventing an attestation replay attack including an attestation target system and an attestation request system for making an attestation request to the attestation target system, wherein the attestation target system includes an integrity measurement block for measuring associated components when an event that affects the integrity of the attestation target system occurs; an identity information verification block for perceiving identity information of the attestation target system and verifying the perceived identity information; an information recording block for recording the measured component and the identity information in a log; a security block including a register for extending and storing the measured components and the identity information; and an attestation service block for generating an attestation response message including the register value and the log in which the identity information is recorded, and wherein the attestation request system receives an attestation response message from the attestation target system on the attestation request and confirms that the attestation response message is generated in the attestation target system.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a conceptional view illustrating an operation flowchart of an attestation replay attack according to the present invention,

FIG. 2 is a block view illustrating a configuration of an attestation system as defined in a trusted computing group (TCG) according to the present invention,

FIG. 3 is a block view illustrating a configuration of an attestation system for verifying and recording identity information according to one exemplary embodiment of the present invention,

FIG. 4 is a flowchart illustrating an attestation operation for preventing an attestation replay attack according to one exemplary embodiment of the present invention, and

FIG. 5 is a flowchart illustrating an operation for verifying identity information according to one exemplary embodiment of the present invention.

### DETAILED DESCRIPTION OF THE PREFERRED EMBODIMENT

Hereinafter, exemplary embodiments of the present invention will now be described in detail with reference to the accompanying drawings. For the detailed description of the present invention, it is considered that descriptions of known components and their related configurations according to the exemplary embodiments of the present invention may be omitted since they are judged to make the gist of the present invention unclear.

For the exemplary embodiments of the present invention, the data may be used through techniques to prevent an attestation replay attack only when a certain platform is in a trusted state and arranged in a predetermined safe site. Here, the term ‘attestation’ means an operation of proving in external network that a certain computing platform is in a trusted state. First of all, an attestation system and data sealing as defined in a trusted computing group (hereinafter, referred to as ‘TCG’) will be described in detail for the purpose of application to the present invention. In this case, the attestation system according to one exemplary embodiment of the present invention has no problem in employing the function to prevent an attestation replay attack in a computing platform using a trusted computing group (TCG) technology by providing the minimum additional functions to the functions as defined in the TCG technology without any change of the functions of the TCG technology. For the following description, a platform may refer to an operating device included in the system (an attestation target system and an attestation request system), and the terms “platform” is described simultaneously with the terms “attestation target system and attestation request system.”

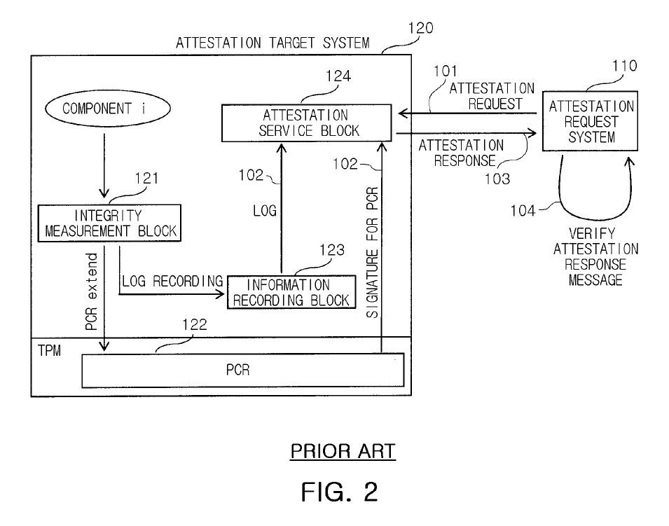

FIG. 2 is a block view illustrating a configuration of an attestation system as defined in a trusted computing group (TCG) according to the present invention.

Referring to FIG. 2, the attestation system as defined in TCG is mainly composed of an attestation target system 110 and an attestation request system 120.

The attestation request system 110 transmits an attestation request message to the attestation target system 120, and verifies the attestation response message when the attestation response message is received from the attestation target system 120 on the attestation request.

The attestation target system 120 may be composed of an integrity measurement block 121, a platform configuration register (hereinafter, referred to as ‘PCR’) 122, an information recording block 123 and an attestation service block 124.

The integrity measurement block 121 measures associated components when event that may affect the integrity of a platform occurs as if a program is executed in the attestation target system 120, and calculates a hash value of the components that are associated the event that may affect the integrity of a platform. And, the integrity measurement block 121 transmits the calculated hash value to the PCR 122 and the information recording block 123. Here, the respective components represent all elements that may affect the integrity of the system, and include, for example, an operating system (OS), a configuration file, a program, a library, etc.

The PCR 122 is included in a trusted platform module (hereinafter, referred to as ‘TPM’), that is, a security block that is a hardware device for security of the computing system, and safely records the orders and hash values of the measured components by means of the integrity measurement block 121. For example, assume that one PCR 122 is present in the TPM of the attestation target system 120, and when the PCR 122 receives a new hash value, the PCR 122 adds the newly inputted hash value to a current PCR value, and updates the new hash value into a PCR value through a hash operation. This hash operation is referred to as ‘PCR extension.’ Here, TPM is a hardware security chip having public key cryptosystem and hash operation functions in addition to the function to safely keep data in the PCR 122.

The information recording block 123 functions to record logs for all components measured in the integrity measurement block 111 after the attestation target system 120 starts to operate. Here, the recorded logs include information that can distinguish the components, and hash values of the components.

Then, the method and attestation system for preventing an attestation replay attack even when an attacker possesses a trusted computing platform using the above-mentioned concept will be described in detail with reference to the accompanying drawings.

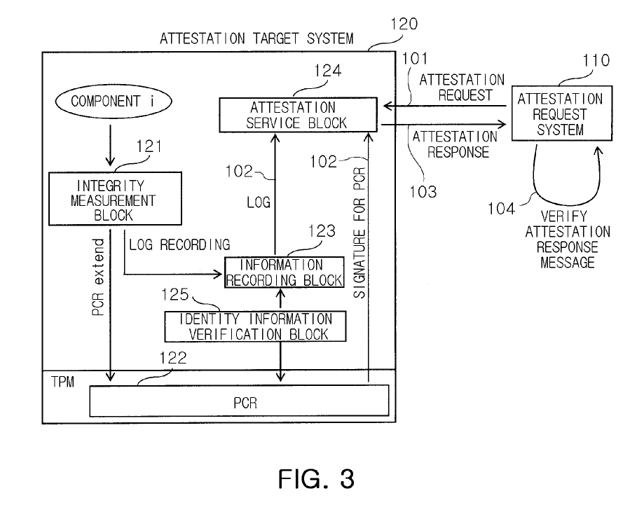

FIG. 3 is a block view illustrating an attestation system for preventing an attestation replay attack according to one exemplary embodiment of the present invention.

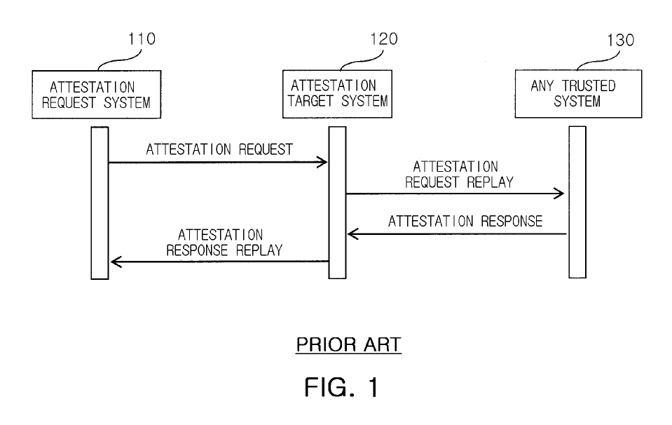

Referring to FIG. 3, the attestation system according to one exemplary embodiment of the present invention is mainly divided into an attestation request system 110 and an attestation target system 120 as in the attestation system defined in the TCG as shown in FIG. 1. Here, the attestation target system 120 may include an integrity measurement block 121, a security block (TPM) including a PCR 122, an information recording block 123 including a log recording the identity information, and an attestation service block 124. These operations are identical to those of the components as shown in FIG. 1. And, the attestation target system 120 further includes an identity information verification block 125 arranged between the PCR 122 and the information recording block 123.

The identity information verification block 125 detects that the identity information of the attestation target system 120 (or a platform) is initially set or changed, verifies whether or not the detected identity information is counterfeited, records the identity information in a log of the information recording block 123 when the verification of the identity information is successful, and extends the identity information into the size of the PCR 122.

Also, the identity information verification block 125 perceives a network address for the use as the identity information so as to verify whether the identity information is counterfeited, and sets the perceived network address as a source address, generates a random number, transmits the source address and the generated random number to a trusted third party (hereinafter, referred to as ‘TTP’) (not shown), and receives signature for the generated random number and the source address from the TTP to confirm whether the perceived network address is a valid address that is able to communicate with external networks.

Then, an operation of generating and verifying an attestation response message will be described in detail in this exemplary embodiment of the present invention.

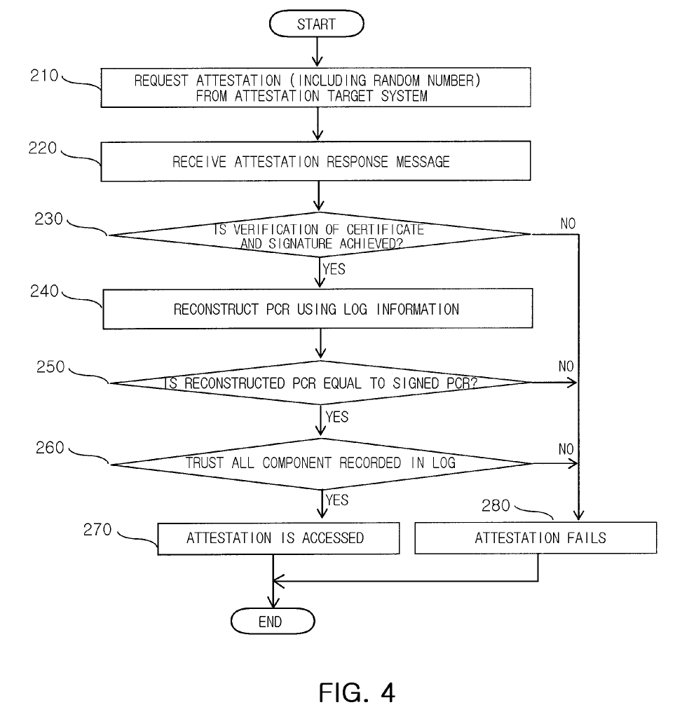

FIG. 4 is a flowchart illustrating an attestation operation for preventing an attestation replay attack according to one exemplary embodiment of the present invention.

Referring to FIG. 4, the attestation request system 110 transmits an attestation request message including a random number to the attestation target system 120 (Operation 210).

Then, the attestation target system 120 prepares for an attestation response message so that it can determine trustability of the attestation target system by confirming whether the attestation request system 110 maintains the integrity of the attestation target system 120, and then transmits the attestation response message to the attestation request system 110. More particularly, the attestation service block 124 in the attestation target system transmits the random number in the request message to the TPM to request signature for the PCR value and the random number. In this case, the TPM generates a signature for and the received random number and a PCR value using an attestation identity key (hereinafter, referred to as ‘AIK’), and then transmits the generated signature and the PCR value to the attestation service block 124. Then, the attestation service block 124 receives the generated signature and the PCR value from the TPM to generate an attestation response message. Here, the attestation response message includes a certificate for AIK and a measured log, wherein the certificate may be used to confirm the received signature, the PCR value, a previously stored signature.

Then, the attestation request system 110 receives the generated attestation response message (Operation 220). Therefore, the attestation request system 110 verifies the received attestation response message to determine whether the attestation target system 120 is trusted (Operation 230). For this purpose, the attestation request system 110 confirms whether the AIK certificate is valid, and verifies a signature for the PCR value using the AIK included in the certificate. When this verification of the signature is not successful, Operation 280 is executed to judge that the attestation request system 110 fails to attest.

On the contrary, when the verification of the signature is successful, the attestation request system 110 judges the PCR value to be stored in the TPM, that is, judges that the PCR value is recorded as a value obtained by measuring the integrity of a platform including the TPM. From these judgment results, the attestation request system 110 reconstructs a PCR value using hash values of the components recorded in information recording block 123 (Operation 240).

The attestation request system 110 confirms the reconstructed PCR value is equal to the signed PCR value (Operation 250). As a result, when the reconstructed PCR value is equal to the signed PCR value, the attestation request system 110 may judge that the measured log is not changed in an arbitrary manner and the information on the operated components is all reflected in the system. Therefore, the attestation request system 110 inspects whether the hash values of the components recorded in the information recording block 123 are calculated from hash values of the trusted components (Operation 260). From the inspection results, the attestation request system 110 judges the integrity of the attestation target system 120 to be maintained since it may trust all of the components (Operation 270), and therefore, the verification of the identity information is successful.

On the contrary, when the Operation 250 or 260 is not satisfied, the attestation request system 110 considers the attestation target system 120 not to be trusted since it judges the verification of the identity information to fail (Operation 280).

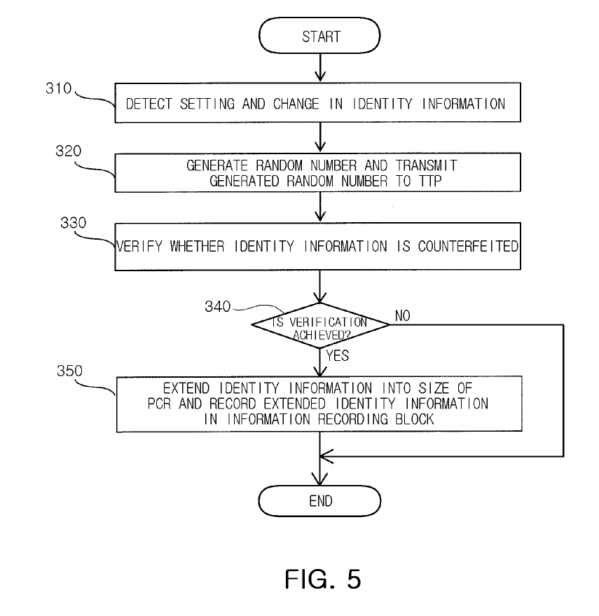

Next, an operation of verifying the identity information when the identity information verification block uses the identity information of the attestation target system (or platform) as a network address in the attestation target system will be described in detail with reference to the accompanying FIG. 5.

The identity information verification block 125 detects the setting or change in the identity information (Operation 310), and generates a random number and transmits the generated random number to the TTP by using the perceived network address as a source address (Operation 320). Therefore, the TTP generates signature for the random number and the source address and transmits the generated signature to the source address.

Subsequently, the identity information verification block 125 verifies whether the identity information is counterfeited (Operation 330). That is to say, the identity information verification block 125 verifies that the TTP has been signed, and confirms that the verification of the identity information is successful (Operation 340). In this case, the operation comes to stop when the verification is not successful.

On the contrary, when the verification of the identity information is successful, the identity information verification block 125 extends the perceived identity information into the size of the PCR 122 and the extended identity information in the information recording block 123 (Operation 350). When the verification of the identity information is successful as described above, the identity information verification block 125 may confirm that the perceived network address is a valid address that is able to communicate with external networks.

When the identity information verification block 125 judges that the perceived network address is valid in this operation, an essential reason for verifying the signature of the TTP is described, as follows.

When the trusted system 130 as shown in FIG. 1 is under the control of the attestation target system 120 and the same attackers, the attackers may set a network address of the trusted system 130 to a network address of the attestation target system 120 in an arbitrary manner. And, when the identity information verification block 125 uses the perceived network address to confirm that it can simply communicate with any of external systems or TTP, the identity information verification block 125 may be cheated as if it communicates with external systems or TTP through an ARP spoofing.

Therefore, the verification of the identity information is successful, and the PCR 122 and the information recording block 123 of the trusted system 130 include information on the network address of the attestation target system 120. When this attestation response message generated in the trusted system 130 includes the network address of the attestation target system 120 as the identity information and is replayed to the attestation request system 110, the attestation request system 110 judges that the attestation response message is generated in the attestation target system 120. That is to say, when the attestation target system 120 is not in a trusted state, the attestation request system 110 may be disguised as if it is in a trusted state.

However, when the verification of the generated signature is successful in the TTP, it is meant that a message is normally transmitted to the TTP, the message including a random number using as a source address the network address which is perceived by the identity information verification block in the trusted system 130. And, the signature is transmitted to the attestation target system 120 when the perceived network address is an address of the attestation target system 120 since the TTP transmits the signature to a source address of the message. Therefore, the identity information verification block 125 in the trusted system 130 does not received the signature from the TTP, and therefore the verification of the identity information is not successful.

When the attestation target system 120 replays the signature from the TTP, the verification of the identity information may be successful. However, when safety equipment of a network to which the attestation target system 120 belongs does not transmit an SYN message but detects an erroneous phenomenon, for example receiving an SYN-ACK message, the attestation target system 120 functions to intercept an attempt for the connection generation, and the connection generation is terminated when the TTP receives the same SYN message with the same sequence number several times for a short time, which make it impossible to make a signature replay attack.

However, when the attestation target system 120 and the trusted system 130 are all present in the same sub network, it is difficult to prevent a replay attack using the verification method.

The identity information verification block 125 should function to supervise an event associated with the identity information that is extended into the size of the PCR, in addition to the supervision of the event in which the identity information is set or changed. This is why, when any identity information is actually recorded in the information recording block 123 and extended into the size of the PCR 122 without setting or changing the identity information, the counterfeited identity information remains recorded in the information recording block 123, and may be cheated like the identity information of the platform through the attestation as described later.

Therefore, the identity information verification block 125 should supervise the associated with the identity information that is extended into the size of the PCR, and verify the extended identity information to prevent the counterfeited identity information from being recorded in the information recording block 123. In connection with the above facts, some attentions should be taken to the attestation procedure as shown in FIG. 5.

First, when the signature of the random number and the PCR value are generated, the PCR value into which the identity information is extended should necessarily included in the data to be signed.

Furthermore, when the identity information verification block 125 verifies whether the components recorded in the information recording block 123 are trusted, the identity information verification block 125 perceives and verifies the identity information of the attestation target system 120, judges whether the trusted components having a recording function are in action, and then does not trust the identity information recorded in the information recording block 123 when there is no component with the above recording function, or the components with the above recording function are not trusted. That is to say, the identity information recorded in the information recording block 123 may not be valid identity information of the attestation target system 120, but be the identity information that is optionally set to make an attestation disguise attack. It is confirmed that the identity information in the information recording block 123 is valid identity information of the attestation target system 120 when the trusted components with the above recording function are in action, and the attestation response message is generated in the attestation target system when the identity information in the information recording block 123 is equal to that of the attestation target system 120.

As described above, the method and an attestation system for preventing an attestation replay attack according to the present invention may be useful to prevent attestation replay attack even when an attacker possesses a trusted computing platform, and to minimize performance degradation in the attestation system when compared to the conventional attestation processing mechanisms by providing an additional simple mathematical operation in verifying an attestation message.

While the present invention has been shown and described in connection with the exemplary embodiments, it will be apparent to those skilled in the art that modifications and variations can be made without departing from the spirit and scope of the invention as defined by the appended claims.

What is claimed is:

1. A method for preventing an attestation replay attack by an attestation target system in an attestation system including the attestation target system and an attestation request system, the method comprising:
measuring associated components when an event that affects the integrity of the attestation target system occurs;
perceiving identity information in the attestation target system and verifying the perceived identity information;
extending the measured components and the identity information to the size of the register and recording the components and the identity information in a log;
generating an attestation response message including the log and a value of the register when an attestation request message is received from the attestation request system; and
transmitting the generated attestation request message to the attestation request system.

2. The method of claim 1, wherein the perceiving of identity information and the verifying of the perceived identity information comprises:
detecting whether the identity information is initially set or changed;
verifying whether the detected identity information is counterfeited; and
extending the identity information into the size of the register and recording the extended identity information in the log when the verification of the identity information is successful.

3. The method of claim 2 wherein the verifying of whether the detected identity information is counterfeited comprises:
perceiving a network address for the use as the identity information;
generating a random number;
transmitting the random number to a trusted third party (TTP) by using the perceived network address as a source address;
receiving signature for the generated random number and the source address from the trusted third party (TTP) and verifying the received signature; and
confirming that the perceived network address is a valid address that is able to communicate with external networks when the verification of the signature is successful.

4. The method of claim 1, wherein the attestation response message includes the log and the register value, the signature for the random number included in the request message and the register value, and a certificate for a public key that is able to confirm the signature.

5. A method for preventing an attestation replay attack by an attestation request system in an attestation system including an attestation target system and the attestation request system, the method comprising:
transmitting an attestation request message including a random number to the attestation target system;
receiving the transmitted attestation request message including a log recording identity information of the attestation target system, and a value of a register extending the identity information; and
verifying the attestation request message to confirm reliability of the attestation target system.

6. The method of claim 5, wherein the verifying of the attestation request message to confirm reliability of the attestation target system comprises:
verifying the signature and a certificate for an attestation identity key that is able to confirm the signature in the attestation request message;
reconstructing a register's own value using the log recording the identity information when the verification of the signature and the certificate is successful;
confirming whether the reconstructed register value is equal to the register value in the attestation request message; and
determining the attestation target system to be trusted when the verification of the identity information is successful by judging reliability of all components recorded in the log and verifying whether the identity information in the log is equal to the identity information of the attestation target system when the two register values are equal to each other.

7. An attestation system for preventing an attestation replay attack including an attestation target system and an attestation request system for making an attestation request to the attestation target system, wherein the attestation target system comprises:
an integrity measurement block for measuring associated components when an event that affects the integrity of the attestation target system occurs;
an identity information verification block for perceiving identity information of the attestation target system and verifying the perceived identity information;
an information recording block for recording the measured component and the identity information in a log;
a security block including a register for extending and storing the measured components and the identity information; and
an attestation service block for generating an attestation response message including the register value and the log in which the identity information is recorded, and
wherein the attestation request system receives an attestation response message from the attestation target system on the attestation request and confirms that the attestation response message is generated in the attestation target system.

8. The attestation system of claim 7, wherein the identity information contains a network address, a serial number, a domain name and a host name.

9. The attestation system of claim 7, wherein the identity information verification block detects the identity information and verifies whether the identity information is counterfeited when the identity information is initially set or changed.

10. The attestation system of claim 9, wherein the identity information verification block generates a random number, sets the network address into a source address, receives signature for the generated random number and the source address from a trusted third party (TTP), and verifies the received signature to confirm that the perceived network address is a valid address that is able to communicate with external networks.

11. The attestation system of claim 7, wherein the information recording block extends the identity information by converting a value of the identity information into a size of the register by using a predetermined algorithm when a size of the identity information is great than the size of the register.

12. The attestation system of claim 7, wherein the attestation response message includes the register value and the log in which the identity information is recorded, the signature for the random number included in the request message and the register value, and a certificate for a public key that is able to confirm the signature.

13. The attestation system of claim 12, wherein the attestation request system verifies the signature for the register value using the certificate and the public key, reconstructs the register value using the log, compares the reconstructed register value with the signed register value to check the reconstructed register value equal to the signed register value, determines if all the components recorded in the log are trusted, and determines whether the attestation target system is able to be trusted when the verification of the identity information is successful by verifying whether the identity information in the log is equal to the identity information of the attestation target system.
